(19) United States
(12) Patent Application Publication
(10) Pub. No.: US 2010/0002727 A1
(43) Pub. Date: Jan. 7, 2010

(54) Inverse Multiplex Protocol

(75) Inventor: Geir Robert Svelmoe, Oslo (NO)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/721,426

(22) PCT Filed: Dec. 14, 2004
(86) PCT No.: PCT/NO04/00387

§ 371 Date: Sep. 10, 2009

(51) Int. Cl. H04J 3/24

(52) U.S. Cl. 370/474

(57) ABSTRACT

The invention relates to inverse multiplexing within telecommunication, and in particular to a versatile inverse multiplex protocol comprising associated state machines and a method for using this protocol allowing a high speed link to be distributed via an inverse multiplexer into a number of lower speed connections in pursuance to G.704 recommendations and using Sa bits.

### FIELD OF THE INVENTION

The invention relates to inverse multiplexing within telecommunication, and in particular to a versatile inverse multiplex protocol comprising associated state machines and a method for using this protocol allowing a high speed link to be distributed via an inverse multiplexer into a number of lower speed connections.

### BACKGROUND OF THE INVENTION

An inverse multiplexer accepts a single, high capacity information stream and splits it up into multiple streams with information, each of which is sent over a separate and lower capacity link, the process is reversed at the receiving end. Resynchronization at the receiving end is one of the major problems that have to be dealt with, as each of the four links may impose different levels of propagation delay on the signal due to for example different route lengths.

In a system with many low speed connections the current invention seeks to provide a high speed link by combining the bandwidth of several low speed links by using inverse multiplexing.

Several products with proprietary multiplexing methods exist and a “Multilink whitepaper” mentions three inverse multiplexing methods: Bit based, Multi-link PPP (MLPPP) and Multi-link Frame Relay (MLFR).

The existing products have automatic activation/de-activation of links based on the quality of the link.

Existing solutions supports multiplexing of up to 8xE1 links.

Another known solution is inverse multiplexing with ATM bonding. The ATM inverse multiplexing involves multiplexing and de-multiplexing of ATM cells in a cyclic fashion among multiple links to form a higher bandwidth.

### Problems with Existing Solutions

The existing solutions are limited to a maximum of eight E1 links. Further, these solutions employ inefficient protocols i.e. overhead reducing effective bandwidth.

To meet the requirements of low transmission delay, a minimized overhead, an increased working range, a reduced number of repeaters, reduced service and maintenance, an increased reliability and robustness, as well as higher availability for the transmission systems, a new and inventive mechanism of inverse multiplex protocol is disclosed.

There exists no versatile Inverse Multiplex Protocol for transporting or spreading high speed data across several low speed data connections. Hence a versatile solution allowing high speed data on one link to be distributed over a suitable number of lower speed links, where the number of lower speed links can vary over a wide range of connections is a wanted solution today. For example, a protocol supporting connections and disconnections of low speed links where the number of low speed links can be within the range of 2-63 without loss of data, is not supported by any known inverse multiplexing protocol. These and other features will be met by the present invention.

### SUMMARY OF THE INVENTION

It is an object of the present invention to provide a method and an arrangement avoiding the above described problems.

The features defined in the independent claims enclosed characterize this method and arrangement.

### BRIEF DESCRIPTION OF THE DRAWINGS

In order to make the invention more readily understandable, the discussion that follows will refer to the accompanying drawing.

FIG. 1 shows a simplified inverse multiplexer arrangement,

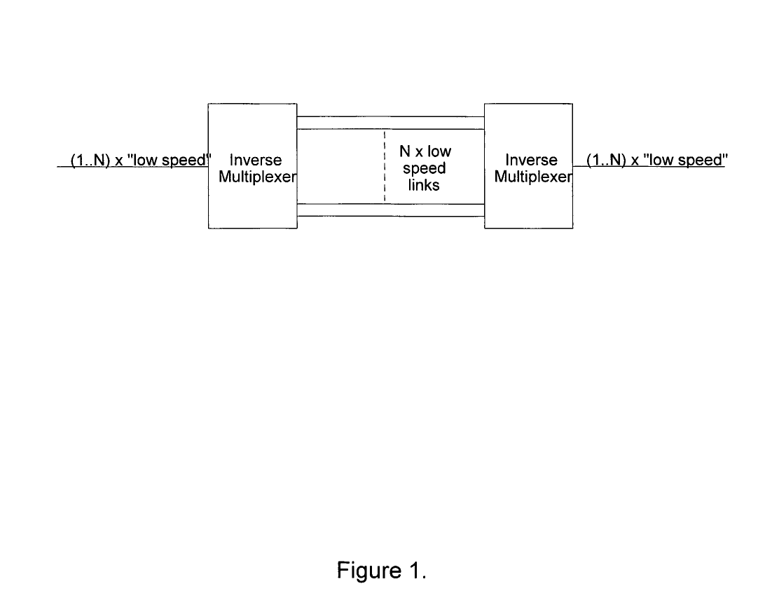

FIG. 2 shows another simplified inverse multiplexer arrangement indicating alien links and links with added delay,

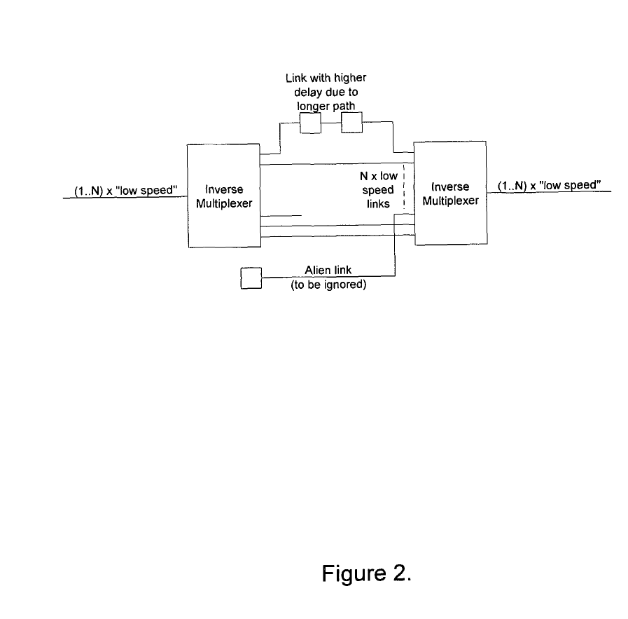

FIG. 3 shows reassembling of MF header,

FIG. 4 illustrates that control information is carried within the MF body,

FIG. 5 shows the MF header contains protocol information for the subsequent MF body,

FIG. 6 shows a receiver state machine,

FIG. 7 shows the transmitter state machine.

### DETAILED DESCRIPTION OF THE INVENTION

The present invention discloses an arrangement and a method for the use of said arrangement, where the arrangement's main feature is its versatility and flexibility within inverse multiplexing and particularly within inverse multiplexing using an inverse multiplexer protocol according to the present invention. In the following a detailed description of the present invention with support in the accompanying drawings is given.

The present invention defines a protocol for inverse multiplexing over G.704 multi frames. The protocol does not introduce overhead to the G.704 and provide means to add and remove links without introducing loss of information.

In the following the wording link is supposed to be read as any communication channel or circuit adapted for transfer of data between two or more nodes.

The protocol also provides delay information for each link in addition to information about link ordering for multiplexing/de-multiplexing.

The protocol defines the behaviour between the local and remote ends of one link and an instance of the protocol applied to one link operates independently of protocol instances applied to other links. However, the implementation that extracts information from a link must correlate the information from all the links and decide which links that are allowed to carry data.

The protocol defines how to identify the remote end so that the implementation can enable inverse multiplexing only for links that are connected to the same remote end. Alien links (which may be due to erroneous configuration of connections) should not be enabled for participation in the multiplexing scheme.

Link quality monitoring is not a part of the inverse mux protocol as this is provided by the G.704 framing.

In the above reference is made to G.704 multi frames and inverse multiplexing, however the solution discussed above can be expanded to cover signal lines with bit transfer rates different from those covered by G.704, wherever the inverse multiplexer technique described with support in table 2 and 3 is applicable, the present invention will be applicable. That is if the lower speed links have enough spare bits (Sa bits or similar) to implement the present protocol it will be applicable.

### A First Preferred Embodiment of the Invention

The present invention will in addition to describing the inverse multiplexing protocol in detail also provide some implementation examples such as state machines to better communicate how the protocol operates.

Note that the concept of the Inverse Multiplex Protocol is broader than the implementation example as shown in the following discussion.

### Protocol Application

The protocol is applied to the SA bits in a G.704 E1 Multi Frame (refer Table 1). Such a Multi Frame provides a total of 40 SA bits.

The protocol operates with two types of multi frame payload: control frames and data frames.

Until the remote end has been identified the application according to the present invention should treat all incoming frames as control frames regardless of what the protocol fields indicates.

This will avoid that a link carrying random data will be able to disturb the already inverse multiplexed data stream and different protocol versions will be identified before a link can participate in the inverse multiplexing.

The protocol version described in this embodiment of the present invention document uses 20 SA bits, the other 20 SA bits may be used to extend the already defined bit fields or to define new ones.

### Basic Communication Primitives

### Multi Frame (MF)

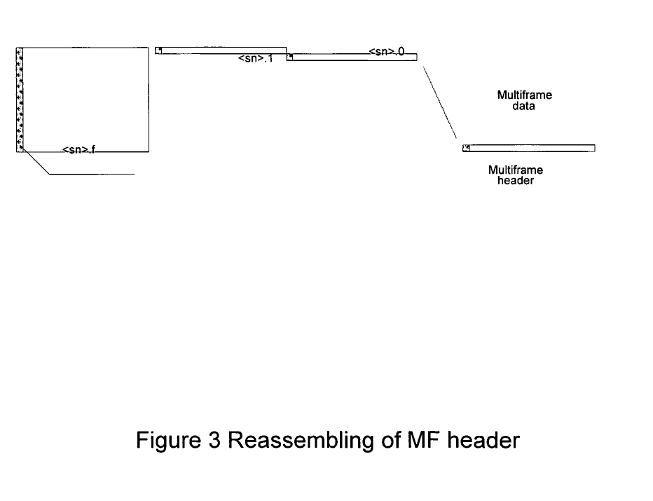

A Multi Frame is built by collecting timeslot zero from 16 consecutive structured E1 frames as shown in FIG. 3

A G.704 framer or a modified G.704 framer is used for multi frame synchronisation and for extracting/inserting the inverse multiplex protocol information.

The content of the MF header is described in table 1.

TABLE 1
Multi Frame header content as per ITU specification G.704.

| | Sub- | | | | | | | | | |
|---|---|---|---|---|---|---|---|---|---|---|
| | Multiframe | Frame | Bits 1 to 8 of the frame | | | | | | | |
| | (SMF) | number | 1 | 2 | 3 | 4 | 5 | 6 | 7 | 8 |
| Multi- | I | 0 | C₁ | 0 | 0 | 1 | 1 | 0 | 1 | 1 |
| frame | | 1 | 0 | 1 | A | Sₐ₄ | Sₐ₅ | Sₐ₆ | Sₐ₇ | Sₐ₈ |
| | | 2 | C₂ | 0 | 0 | 1 | 1 | 0 | 1 | 1 |
| | | 3 | 0 | 1 | A | Sₐ₄ | Sₐ₅ | Sₐ₆ | Sₐ₇ | Sₐ₈ |
| | | 4 | C₃ | 0 | 0 | 1 | 1 | 0 | 1 | 1 |
| | | 5 | 1 | 1 | A | Sₐ₄ | Sₐ₅ | Sₐ₆ | Sₐ₇ | Sₐ₈ |
| | | 6 | C₄ | 0 | 0 | 1 | 1 | 0 | 1 | 1 |
| | | 7 | 0 | 1 | A | Sₐ₄ | Sₐ₅ | Sₐ₆ | Sₐ₇ | Sₐ₈ |
| | II | 8 | C₁ | 0 | 0 | 1 | 1 | 0 | 1 | 1 |
| | | 9 | 1 | 1 | A | Sₐ₄ | Sₐ₅ | Sₐ₆ | Sₐ₇ | Sₐ₈ |
| | | 10 | C₂ | 0 | 0 | 1 | 1 | 0 | 1 | 1 |
| | | 11 | 1 | 1 | A | Sₐ₄ | Sₐ₅ | Sₐ₆ | Sₐ₇ | Sₐ₈ |
| | | 12 | C₃ | 0 | 0 | 1 | 1 | 0 | 1 | 1 |
| | | 13 | E | 1 | A | Sₐ₄ | Sₐ₅ | Sₐ₆ | Sₐ₇ | Sₐ₈ |
| | | 14 | C₄ | 0 | 0 | 1 | 1 | 0 | 1 | 1 |
| | | 15 | E | 1 | A | Sₐ₄ | Sₐ₅ | Sₐ₆ | Sₐ₇ | Sₐ₈ |

To uniquely identify each SA bit for protocol purpose the bits will according to the present invention be assigned subscript numbers from SA₀₀ to SA₃₉. The following table is a subset of Table 1 and it shows only the bits that are defined by the protocol and their protocol naming

TABLE 2
IM Protocol naming of SA bits.

| | Sub- | | | | | | | | | |
|---|---|---|---|---|---|---|---|---|---|---|
| | Multiframe | Frame | Bits 1 to 8 of the frame | | | | | | | |
| | (SMF) | number | 1 | 2 | 3 | 4 | 5 | 6 | 7 | 8 |
| Multi- | I | 1 | | | | SA₀₀ | SA₀₄ | SA₀₈ | SA₁₂ | SA₁₆ |
| frame | | 3 | | | | SA₀₁ | SA₀₅ | SA₀₉ | SA₁₃ | SA₁₇ |
| | | 5 | | | | SA₀₂ | SA₀₆ | SA₁₀ | SA₁₄ | SA₁₈ |
| | | 7 | | | | SA₀₃ | SA₀₇ | SA₁₁ | SA₁₅ | SA₁₉ |
| | II | 9 | | | | SA₂₀ | SA₂₄ | SA₂₈ | SA₃₂ | SA₃₆ |
| | | 11 | | | | SA₂₁ | SA₂₅ | SA₂₉ | SA₃₃ | SA₃₇ |
| | | 13 | | | | SA₂₂ | SA₂₆ | SA₃₀ | SA₃₄ | SA₃₈ |
| | | 15 | | | | SA₂₃ | SA₂₇ | SA₃₁ | SA₃₅ | SA₃₉ |

### Protocol Fields/SA Bit Assignment

The following table defines the protocol fields, their meaning and their assignment to specific SA bits. The bits are listed in most significant to least significant order for multi bit fields. Bits with consecutive bit numbering may be written as SAₓₓ-SA_{yy}, where both SAₓₓ and SA_{yy} are included.

TABLE 3
IM Protocol fields and assignment of SA bits

| Bit(s) | Description |
|---|---|
| SA₀₀ | Identifies the MF as either a |
| (1 bit) | “Control type MF” (0) or as a “Data type MF” |
| | (1). See also SA₁₇ and SA₁₉. |
| | The information in SA₀₀ can be subject to |
| | noise. In order to improve the resistibility |
| | to noise, the information is duplicated in |
| | two other SA-bits. The receiver can then |
| | make a majority decision. |
| A₀₁ | Signals to the remote end whether “Data type |
| (1 bit) | MFs” or not may be transmitted on this link. |
| | This will enable a graceful controlled start |
| | and stop of separate E1 links without causing |
| | loss of data. |
| | Setting this bit (1) when adding an E1 link |
| | indicates that the originating party have |
| | established synchronisation and that the |
| | remote end may start to send “Data type MF”. |
| | Clearing this bit (0) when removing an E1 |
| | link indicates that the remote end should |
| | stop sending data on this link. |
| | The protocol also allows for this bit being |
| | manipulated for other purposes than |
| | addition/removal of E1 links. Examples may be |
| | for flow control or for indication of problems |
| | in one direction preventing data from being |
| | received correctly (bit errors, to long delay, |
| | etc.) |
| SA₀₂-SA₀₇ | Minor sequence number to identify a MF's |
| (6 bits) | relative position among MFs sent at the same |
| | time from the transmitting party. The minor |
| | sequence numbers do not need to be contiguous |
| | for a set of MFs. This means that it may be a |
| | fixed relationship between E1 link and minor |
| | number at the transmitting side. See the |
| | description of the MUX method for more |
| | information. |
| SA₀₈-SA₁₅ | Major sequence number to identify MFs sent at |
| (8 bits) | the same time. The time it takes to transmit |
| | one MF is 2 ms and by using 8 bits the |
| | sequence number will start repeating itself |
| | after 512 ms. |
| SA₁₆ | Not currently assigned. Should be set to one |
| | at the originating side. The receiver shall |
| | ignore the state of this bit. |
| SA₁₇ | Duplication of the information in SA₀₀ |
| SA₁₈ | Not currently assigned. Should be set to one |
| | at the originating side. The receiver shall |
| | ignore the state of this bit. |
| SA₁₉ | Duplication of the information in SA₀₀ |
| SA₂₀-SA₃₉ | Not currently assigned. Should be set to one |
| (20 bits) | at the originating side. The receiver shall |
| | ignore the state of these bits. |

### Data Type Multi Frame

A “Data type MF” (e.g. SA₀₀=“1”) indicates that all of the MF's body content is to be forwarded according to the low level multiplex algorithm.

### MUX Method 1

The multiplexing method works on a set of active links. Active means that transmitter and receiver end are ready for data, however not necessarily in both directions at the same time.

The transmitter distributes the high-speed data on a set of data type MF. All the multi frames have the same major sequence number and the whole MF contains the same type of payload.

The MUX method will distribute the high-speed data on the multi frames in a round robin scheme using one byte fragments. The minor sequence numbers indicate the multi frame sequence order used. This is vital for correct reassembly. The minor sequence numbers does not need to be consecutive, but they must be unique. The round robin scheme start at the multi frame/link with the lowest minor sequence number and the rest of the multi frames/links follows in ascending order. The sequence wraps to the multi frame/link with the lowest minor sequence number after the link with the highest minor sequence number.

When the multi frames are filled up, the sequence is repeated at a new set of multi frames. The new set will have their major sequence number incremented by one. Note that the transmitting end should not buffer a MF but rather have the multiplexed data delivered just in time to be transmitted,

### Example

There are five links numbered as follows: 5, 3, 6, 9 and 15. The round robin sequence will then be: 3, 5, 6, 9, 15, 3, 5 and so on.

The receiver has to reassemble the data in the same order to be able to reconstruct the high-speed data.

The receiver has to compensate for transmission delay in order to get a complete set of multi frames. This means that a fast link must buffer some data while a slow link will deliver data just as they arrive.

### Control Type Multi Frame

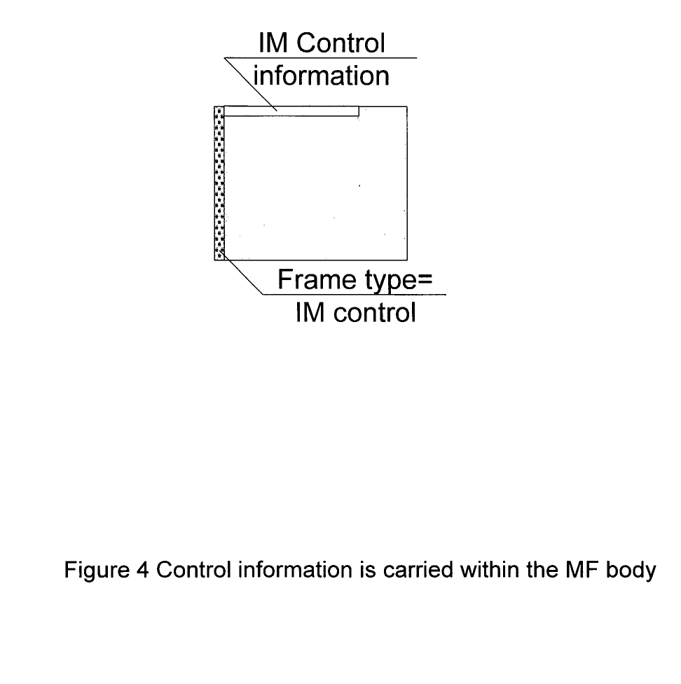

A “Control type MF” (e.g. SA₀₀=“0”) indicates that the MF's body carries control information and is to be processed by the logic associated with the E1 link the frame is received on. FIG. 4 depicts how this is organised.

The currently defined control information fields are listed in the table below. The bits are listed in most significant to least significant order for multi bit fields. Bits with consecutive bit numbering may be written as CFₓₓ-CF_{yy} where both CFₓₓ and CF_{yy} are included.

TABLE 4
Control type MF field definition

| Bit(s) | Description |
|---|---|
| CF₀₀-CF₃₁ | Checksum₁₆ + 1 |
| (32 bits) | The procedure for calculating is as follows: |
| | 1) The rest of the control frame is divided |
| | into 246 unsigned 16-bit-words. |
| | 2) A unsigned 32-bit sum of all the 16-bit- |
| | words are calculated. |
| | 3) The 32-bit sum is incremented by 1. |
| | 4) The result is stored in the start of the |
| | control frame. |
| CF₃₂-CF₆₃ | Protocol version (only one exists as of |
| (32 bits) | today) |
| CF₆₄-CF₁₁₁ | A unique identifier for the Multi Frame |
| (48 bits) | originating end. Typically this is an |
| | Ethernet MAC address associated with the |
| | node. |
| CF₁₁₂-CF₁₂₇ | Multiplexing scheme (only one exists as of |
| (16 bits) | today) |
| CF₁₂₈-CF₁₅₉ | Vendor ID |
| (32 bits) | |
| CF₁₆₀-CF₁₉₁ | Realization build number |
| (32 bits) | |

Multi Frame Header Vs. Multi Frame Body

To minimise the delay introduced, a MF should not be buffered for a longer time than strictly needed. This means that the early bits of a MF may already be forwarded on the high capacity link before the complete MF header has been received. To ensure that all protocol information is received completely before the corresponding MF body is being processed, the MF header contains protocol information for the subsequent MF body.

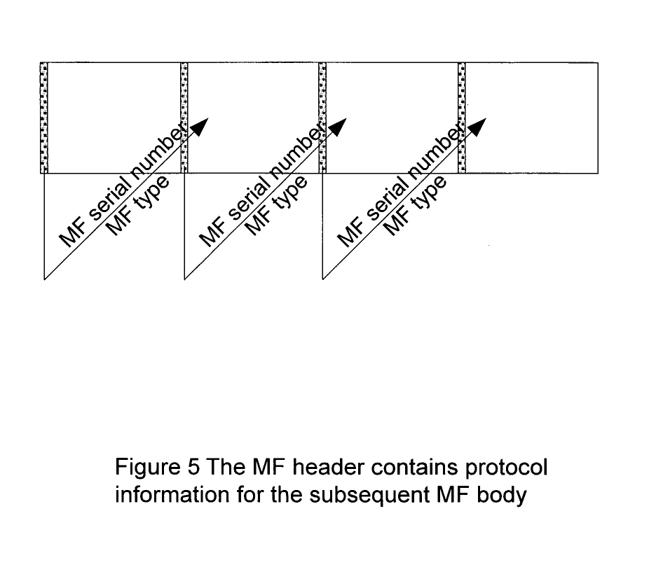

This is illustrated in FIG. 5.

### Protocol State Machines

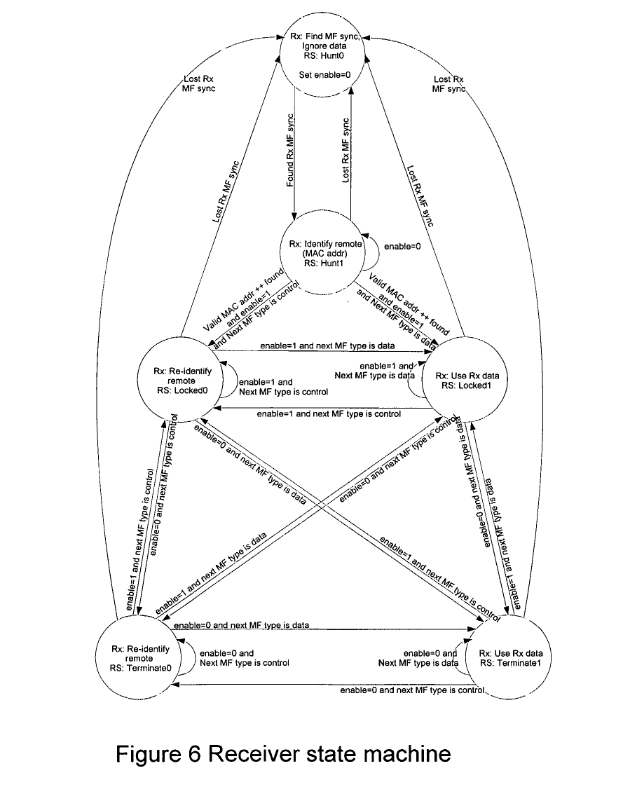

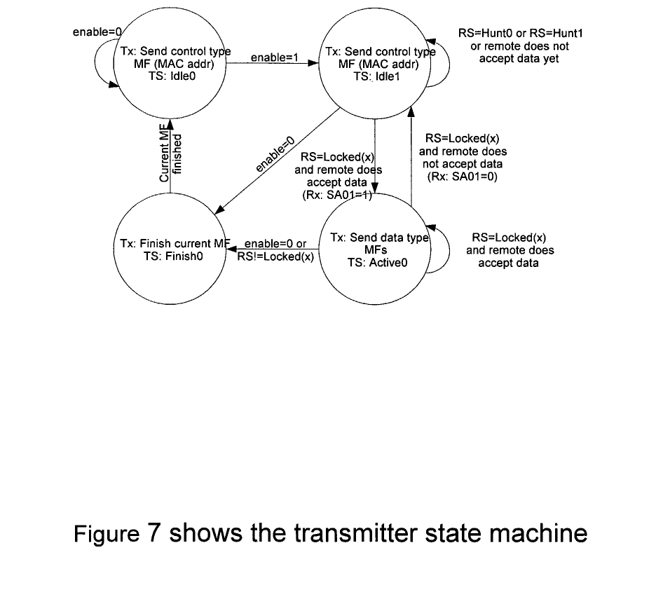

For better understanding of the protocol behaviour according to the present invention the following sections discusses state machines. The state machines could also be realized by using other internal signals in addition to the ones shown here, i.e. in the FIGS. 6 and 7.

### Receiver State Machine

The state machine in FIG. 6 should be instantiated for each physical link that is to be a part of the inverse multiplexer.

### Short Description:

The receiver starts disabled, but it tries to synchronise with possible Multi Frames arriving on the interface. When MF synchronisation is established the receiver must identify the remote end to determine if this link is to be incorporated into the inverse multiplexing traffic.

Once the link is accepted for data traffic and the link becomes enabled the data received will be made available to the block that reassembles data from several links into one data stream.

The receiver is only dependant on the enable signal and the received Multi Frames. When the receiver is ready to receive data type Multi Frames this will be reflected in the outgoing MFs (Tx:SA₀₁).

Note that before the local receiver indicates that it is ready for data type MFs it must have used the control type MFs to synchronise the major sequence number with the other active links. The impact of not doing this is easily seen if the new link has an extra transmission delay that is more than the duration of one MF (it will arrive after the reassembling have started).

### Transmitter State Machine

The state machine in FIG. 7 should be instantiated for each physical link that is to be a part of the inverse multiplexer.

### Short Description:

The transmitter is continuously sending control type MFs while it is waiting for the link to be enabled. Once the link is enabled the transmitter continues to send control type Multi Frames until the local receiver has locked to its incoming stream and the remote signals that it is willing to accept data on this link. The control type Multi Frames sent are in phase with Multi Frames sent on other links and have a major sequence number identical to the other Multi Frames. The minor number must be assigned as if the Multi Frame was carrying data (to better obtain remote synchronisation). The remote receiver will ensure that the data is suppressed from reassembling as long as the Multi Frame is a control type Multi Frame.

The protocol bit indication of whether the local receiver is ready for data type MFs or not (Tx SAO₁), is supplied by the local receiver state machine.

The local receiver supplies the bit indicating whether the remote receiver is ready for data type MFs (Rx SA₀₁). Once this bit is activated the link will start to transmit data payload.

While in the foregoing the present invention has been discussed with examples of preferred embodiments, however it should be understood that the principles as shown for the use of a number of E1 links as the lower speed data links also applies to T1 links.

### ADVANTAGES OF THE INVENTION

The invention introduces zero overhead to a G.704 Multi Frame.
The invention provides for a simple implementation in hardware.
The invention can handle links connected in random order
The invention provide means for identifying the remote end and hence an erroneously connected link will not be able to corrupt the reassembling of data from valid links. This will be true even if the alien link also carries valid protocol information.
The invention is able to identify different remote parties based on the unique node identifier received.

Abbreviations

| | |
|---|---|
| CFₓₓ | Control Frame bit xx |
| E1 | European Digital Signal 1. European standard |
| | for digital physical interface at 2.048 Mbps. |
| E2 | European Digital Signal 2. Data signal that |
| | carries four multiplexed E1 signals. Effective |
| | data rate is 8448 Mbps. |
| E3 | European Digital Signal 3. European standard |
| | for digital physical interface at 34.368 Mbps. |
| | It can simultaneously support 16 E1 circuits. |
| HW | Hardware |
| MAC | Media Access Controller |
| MF | Multi Frame |
| MFA | Multi Frame Alignment |
| ML-PPP | Multi Link PPP |
| MLFR | Multi Link Frame Relay |
| MUX | Multiplexer, Multiplexing, . . . |
| PPP | Point to Point Protocol |
| RS | Receiver State |
| SW | Software |
| TS | Transmitter State |

### REFERENCES

G.704, G.7043, G.8080

1. A bidirectional telecommunication or data communication node comprising a flexible inverse multiplexer, the inverse multiplexer further comprises a receiver state machine and a transmitter state machine for inverse multiplexing and reconstitution of data streams over G.704
characterised in that a first link having higher data transfer speed than a number of second links is communicating through the telecommunication or data communication node using an inverse multiplex protocol applied thereto, and the inverse multiplex protocol is applied to Sa bits in a G704 EI multi frame and every physical link on the inverse multiplexer comprises a transmitter state machine and a receiver state machine.

2. A bidirectional telecommunication or data communication node according to claim 1,
characterised in that each of the 40 Saₙₙ bits in a G.704 Multi Frame is reassigned subscript numbers in a cyclic manner from SA₀₀ to SA₃₉.

3. (canceled)

4. A bidirectional telecommunication or data communication node according to claim 3,
characterised in that
at least one of the SA bits, preferably three of the SA bits, identifies whether the multi frame is a “Control type Multi Frame” or a “Data type Multiframe”, a SA bit is dedicated for signalling the adding or removing of a link,
a number of SA bits, preferably six, is reserved for identification of a Multi Frame's relative position among Multi Frames sent simultaneously from a transmitting party, and
a number of SA bits, preferably 8 bits, is reserved for identification of Multi Frames sent simultaneously.

5. (canceled)

6. A method for receiving and transmitting data comprising a receiver state machine and a transmitter state machine for an inverse multiplexer for Multi Frame synchronisation over G.704 with a transmitting party where the receiver state machine is
characterised in that the receiver state machine traverses in subsequent order at least the following states:
a) at initialisation defining the receiver state machine as disabled,
b) the receiver state machine tries to synchronize with arriving Multi Frames, and if synchronisation is established,
c) the receiver state machine tries to identify a remote end, if the remote end is identified, valid and the next Multi Frame type is data, then the receiver state machine is enabled, and the data is read to a reconstitution block, and
e) the receiver state machine tries to identify a remote end, if the remote end is identified, valid and the next Multi Frame type is control, then the receiver state machine is enabled and the receiver state machine tries to identify a remote end.

7. A method according to claim 6, characterised in that state b is a direct point of return for every state that looses synchronization.

8. A method for receiving and transmitting data comprising a number of transmitter state machines and a number of receiver state machines for inverse multiplexing of Multi Frames over G.704 and synchronisation with a receiving party where the transmitter state machines are characterised in that every one of the transmitter state machines traverses in subsequent order at least one of the following states:
a) the transmitter state machine is continuously sending control type Multi Frames and the transmitter state machine is waiting for a corresponding link to be enabled, if the corresponding communication link is enabled, then
b) the transmitter state machine continues to send control type Multi Frames until an associated remote receiver receives the control type Multi Frames and locks to the incoming data and the remote receiver signals acceptance of data type Multi Frames, and then
c) the transmitter state machine will continue to send data type Multi Frames, when the corresponding communication link is enabled and the remote receiver accepts data type Multi Frames.

9. A method according to claim 8, characterised in that each of the transmitter state machines may further traverse the following state:
d) the transmitter state machine sends data type Multi Frames, the corresponding communication link is disabled by the remote receiver then the transmitter responds by finishing a current Multi Frame.

10. A method according to claim 8, characterised in that a transmitter state machine after finishing the transmission of a current Multi Frame returns to state a.

11. A bidirectional telecommunication or data communication node comprising a flexible inverse multiplexer, the inverse multiplexer further comprises a number of receiver state machines and a number of transmitter state machine for inverse multiplexing and reconstitution of data streams over G.704 characterised in that the receiver state machine is adapted to synchronize with receiving control type Multi Frames and a single SA bit in the inverse multiplexer protocol enables the transmitter state machine to send data type Multi Frames.

12. A communication node according to claim 11, characterised in that the receiver state machine is adapted to identify a transmitting party.

13. A communication node according to claim 11, characterised in that a single SA bit in the inverse multiplexer protocol enables the receiver state machine to indicate removal or addition of an associated link/connection.

14. A communication node according to claim 11, characterised in that a number of SA bits, preferably six, is reserved for identification of a Multi Frame's relative position among Multi Frames sent simultaneously from a transmitting party to a remote receiving end.

15. A communication node according to claim 11, characterised in that a number of SA bits, preferably 8 bits, is reserved for identification of Multi Frames sent simultaneously from a transmitting party to a remote receiving end.

16. A communication node according to claim 11, characterised in that the inverse multiplexer is adapted for inverse multiplexing of 1 to 63 E1 links.

17. A communication node according to claim 11, characterised in that the transmitter state machine is adapted to send control type Multi Frames on a link and to cheque for enable on the link.

18. (canceled)
